(19) United States
(12) Patent Application Publication
(10) Pub. No.: US 2015/0323998 A1
(43) Pub. Date: Nov. 12, 2015

(54) ENHANCED USER INTERFACE FOR A WEARABLE ELECTRONIC DEVICE

(71) Applicant: QUALCOMM INCORPORATED, SAN DIEGO, CA (US)

(72) Inventors: Shrinivas Shrikant Kudekar, Somerville, NJ (US); Aleksandar Jovicic, Jersey City, NJ (US); Thomas Joseph Richardson, South Orange, NJ (US)

(73) Assignee: QUALCOMM INCORPORATED, SAN DIEGO, CA (US)

(21) Appl. No.: 14/270,454

(22) Filed: May 6, 2014

(51) Int. Cl. G06F 3/01

(52) U.S. Cl. CPC G06F 3/017; G06F 3/014

(57) ABSTRACT

Methods, systems and devices are provided for receiving input in a wearable electronic device from positioning an object near the wearable electronic device. Embodiments include an image sensor receiving an image. An input position of the object near the wearable electronic device may be determined with respect to a frame of reference. The determined input position may be one of a plurality of positions defined by a frame of reference and may be associated with an input value. A visual indication regarding the input value may be provided on a display of the wearable electronic device. At least one of an anatomical feature on the wearer and a received reference input on the anatomical surface may be used to determine the frame of reference.

### BACKGROUND

Miniaturization of advanced electronics has lead to wearable electronics, such as wrist-worn smartwatches. A goal for the design of smartwatches is to provide all of the functionality typically associated with a smartphone in a device about the size of a conventional wristwatch. However, the small size of these wearable devices presents challenges in providing efficient and easy controls for the user to operate all those advanced functions. For example, while touch-screens used in current smartphones enable fast, convenient, and user-friendly input techniques, those same techniques have more limited application for a smartwatch due to the small size of its display. In particular, the small screen on a smartwatch, which is not much bigger than the face of a conventional watch, is not a practical interface for typing and interacting with icons. Due to its small size, a smartwatch screen can be immediately obstructed by a wearer's relatively large fingertips when interacting with that screen.

### SUMMARY

Systems, methods, and devices of various embodiments enable a wearable electronic device to receive user inputs in response to the user positioning an object near the wearable electronic device. An image sensor included in the wearable electronic device may receive an image and the image may be processed by the wearable electronic device to determine a position of the object near the wearable electronic device with respect to a frame of reference relative to an anatomical input surface on the wearer of the wearable electronic device. The determined position may be one of the plurality of positions associated with an input value. Additionally, a visual indication regarding the input value may be provided on a display of the wearable electronic device.

Systems, methods, and devices of various embodiments may enable an anatomical feature on the wearer of the wearable electronic device to be detected from the image. In addition, the frame of reference may be determined or fixed relative to the anatomical feature, wherein the frame of reference defines the plurality of positions associated with the input value as being at least one of on and hovering over the anatomical input surface on the wearer of the wearable electronic device. Alternatively, a reference input received from the image sensor may correspond to the object being in contact with a portion of the anatomical input surface, wherein the frame of reference may be fixed relative to a reference position of the contacted portion of the anatomical input surface.

Systems, methods, and devices of various embodiments may enable the input value to be associated with an input selection in response to the determined position corresponding to the object being in contact with a portion of the anatomical input surface. Alternatively, the input value may be associated with a pre-selection input in response to the determined position corresponding to the object hovering over a portion of the anatomical input surface. Also, the visual indication may include enhancing the appearance of at least one of a plurality of input values displayed on the wearable electronic device.

Systems, methods, and devices of various embodiments may enable a wearable electronic device to receiving input from a gesture sensor of the wearable electronic device. The received input may correspond to a movement by the wearer that can be sensed by the gesture sensor. An inference engine may process the received input to recognize a gesture corresponding to the movement by the wearer, and implement a correlated command or function. For example, the image sensor may be activated in response to recognizing the gesture.

Further embodiments may include a smartwatch having a processor configured with processor-executable software instructions to perform various operations corresponding to the methods discussed above.

Further embodiments may include a smartwatch having various means for performing functions corresponding to the method operations discussed above.

Further embodiments may include a non-transitory processor-readable storage medium having stored thereon processor-executable instructions configured to cause a processor in a smartwatch to perform various operations corresponding to the method operations discussed above.

### BRIEF DESCRIPTION OF THE DRAWINGS

The accompanying drawings are presented to aid in the description of embodiments of the disclosure and are provided solely for illustration of the embodiments and not limitation thereof.

FIG. 1 is a perspective view of an embodiment wearable electronic device worn on a wrist with a finger of a wearer in phantom.

FIG. 2A is a plan view of an embodiment wearable electronic device on a wearer's wrist.

FIG. 2B is a side elevation view of the wearable electronic device and wearer's wrist of FIG. 2B.

FIG. 3A is a side elevation view of an embodiment wearable electronic device with a finger approaching an anatomical input surface.

FIG. 3B illustrates visual indications on the display of the wearable electronic device, corresponding to the finger position of FIG. 3A, suitable for use in various embodiments.

FIG. 4A is a side elevation view of an embodiment wearable electronic device with a finger hovering over an anatomical input surface.

FIG. 4B illustrates visual indications on the display of the wearable electronic device, corresponding to the finger position of FIG. 4A, suitable for use in various embodiments.

FIG. 5A is a side elevation view of an embodiment wearable electronic device with a finger contacting an anatomical input surface.

FIG. 5B illustrates visual indications on the display of the wearable electronic device, corresponding to the finger position of FIG. 5A, suitable for use in various embodiments.

FIGS. 6A-6C illustrate two-dimensional field of view images from the perspective of the image sensor of a wearable electronic device suitable for use in various embodiments.

FIGS. 7A-7B illustrate relief views of the wearer's fingers depicted in FIGS. 6B and 6C respectively.

FIG. 8 illustrates an embodiment wearable electronic device and an anatomical input surface on a wearer's hand 12.

FIG. 9 illustrates an embodiment wearable electronic device recognizing a swipe input.

FIGS. 10-13 illustrate various exemplary gestures that may be recognized for providing input to a wearable electronic device suitable for use in various embodiments.

FIG. 14 is a schematic block diagram of an embodiment device for gesture recognition.

FIG. 15 is a schematic block diagram for use in various embodiments.

FIG. 16 is a process flow diagram of an embodiment method of receiving input in a wearable electronic device.

FIG. 17 is a process flow diagram of an embodiment method of receiving input in a wearable electronic device.

FIG. 18 illustrates two wearable electronic devices used together to detect a movement gesture by a wearer suitable for use in various embodiments.

FIG. 19 is a process flow diagram of an embodiment method of receiving input in a wearable electronic device.

FIG. 20 illustrates an embodiment wearable electronic device.

### DETAILED DESCRIPTION

The various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the disclosure or the claims. Alternate embodiments may be devised without departing from the scope of the disclosure. Additionally, well-known elements of the disclosure will not be described in detail or will be omitted so as not to obscure the relevant details of the disclosure.

The word “exemplary” is used herein to mean “serving as an example, instance, or illustration.” Any implementation described herein as “exemplary” is not necessarily to be construed as preferred or advantageous over other implementations. Additionally, use of the words, “first,” “second,” “secondary,” or similar verbiage is intended herein for clarity purposes to distinguish various described elements, and is not intended to limit the invention to a particular order or hierarchy of elements.

As used herein, the term “image” refers to an optical counterpart of an object captured by an image sensor. The optical counterpart may be light or other radiation from the object, such as reflected in a mirror or refracted through a lens that is captured by an image sensor.

As used herein, the term “image sensor” refers to a device that may use visible light (e.g., a camera) and/or other portions of the light spectrum, such as infrared, to capture images of objects in its field of view. The image sensor may include an array of sensors for linear, two-dimensional or three-dimensional image capture. Images captured by the image sensor, such as photographs or video, may be analyzed and/or stored directly in the wearable electronic device and/or transmitted elsewhere for analysis and/or storage.

As used herein, the term “anatomical” refers to portions of a bodily structure of a wearer. Also, the terms “anatomical surface” or “anatomical input surface” are used herein interchangeably to refer to an outside surface or outermost layer of a bodily structure (i.e., the epidermis) or material covering at least a portion of that bodily structure (e.g., a shirt sleeve). The anatomical input surface need not be bare skin, but may be covered by a material, such as a glove, sleeve or other clothing or accessory.

As used herein the term “anatomical feature” refers to an identifiable attribute of the wearer's anatomy or a physical extension thereof that establishes an anatomical location. For example, one or more knuckles may be readily identifiable anatomical features of a wearer's hand. Similarly, an accessory worn on a wearer's arm, such as an emblem or button attached to a sleeve may be an anatomical feature of a wearer's arm.

As used herein, the term “appendage” refers to a projecting body part of a wearer with a distinct appearance or function, such as a wearer's arm including their hand and wrist.

As used herein, the term “frame of reference” refers to an arbitrary set of axes with reference to which the position or motion of an object may be defined or determined. The arbitrary set of axes may be three straight-line axes that each intersect at right angles to one another at a point of origin. Such a point of origin may be fixed relative to an identified anatomical feature or a calibration position provided from a reference input corresponding to an object contacting an identified portion of an anatomical input surface. In this way, the position or motion of the object may be measuring using a system of coordinates established by the frame of reference.

As used herein, the term “visual indication” refers to a sign or piece of information that indicates something, which is observable through sight or seeing.

The various embodiments relate to a wearable electronic device, such as a smartwatch, that may include an enhanced system for receiving user inputs. An image sensor, such as a camera, may be provided along with a processor capable of analyzing images obtained by the image sensor. By mounting the image sensor on an edge of the wearable electronic device facing an adjacent anatomical region of the wearer, such as the wearer's hand or forearm, an otherwise ordinary anatomical region of a wearer may become a virtual keyboard, touch screen or track pad. The image sensor may capture images that the processor may analyze to detect the presence, position, and/or movement of an object, used for user input selection, relative to that adjacent anatomical region. The object may be a fingertip of the other hand or a stylus held by the other hand. The processor may translate the position and/or movement of the object to an input associated with that position and/or movement. Each position of the object, either contacting or hovering over the surface of the adjacent anatomical region may correspond to a key on a virtual keyboard or virtual touchscreen. Similarly, that adjacent anatomical region may act as a virtual track pad, since movements of the object may be reflected by corresponding visual indications of such movement on a display of the wearable electronic device.

In an embodiment, the wearable electronic device may include one or more additional sensors capable of detecting movements of muscles and tendons in the user's wrist. Sensors may be included for detecting spatial movement of the wearable electronic device itself. The processor of the wearable electronic device may receive and analyze sensor inputs using a knowledge base and an inference engine that may be trained to recognize certain finger and/or hand movements as command gestures. Such command gestures may be used to provide additional user inputs to the wearable electronic device. In other words, sensors measuring pressure, forces, muscle contraction (e.g., EMG sensors), and/or skin proximity in the wearable electronic device and/or strap may be used to detect specific muscle or tendon movements that the wearable electronic device learns to associate with specific finger and/or hand gestures. Other sensors such as a gyroscope and accelerometers may provide further information that may be combined with the finger/hand movement sensor data. A recognized gesture may be used to activate features and/or components of the wearable electronic device, such as the image sensor.

In an embodiment, one such wearable electronic device may be used on each wrist of the wearer to decipher movements associated with more complex gestures, such as sign language, which may be used to provide controls and/or other user input to the wearable electronic device.

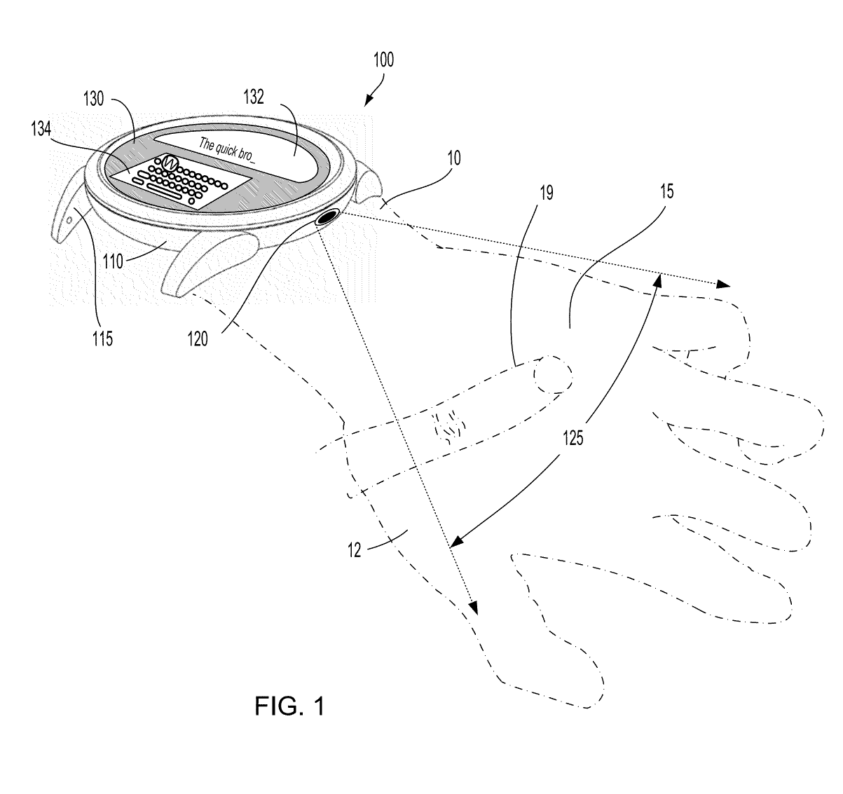

FIG. 1 is a perspective view of an embodiment wearable electronic device on a wrist of a wearer, with the wearer's wrist 10, hand 12, and fingertip 19 from the other hand shown in phantom. The wearable electronic device 100 illustrated in FIG. 1 is a smartwatch, but the wearable electronic device of various embodiments need not be or emulate a timepiece and need not be a wrist-worn device and may be any other type of wearable electronic device. For example, the wearable electronic device may be incorporated into glasses, a brooch, or other wearable accessory. In various embodiments, the wearable electronic device may include a casing 110, an image sensor 120 and a display 130. The image sensor 120 includes a field of view 125 projecting out over an adjacent anatomical input surface 15 on the wearer. In this way, an object (such as, a fingertip 19 of that wearer's other hand or any other suitable object like a pen or stylus) may interact with the adjacent anatomical input surface 15 as if the anatomical input surface 15 were a keyboard or track pad. The image sensor 120 may capture the positions and/or movements of the fingertip 19 to receive as user inputs for the wearable electronic device.

The anatomical input surface 15 is illustrated as the back of the wearer's hand 12, but may be another nearby anatomical area such as the wearer's forearm or palm when the wearable electronic device is mounted on a wrist. In various embodiments, the anatomical input surface 15 may be significantly larger than the display on the wearable electronic device 100. This may allow the relatively large human fingertips to more easily distinguish between positions on an input surface when attempting to input information and/or commands to the wearable electronic device.

The shape and size of the casing 110 may vary to accommodate aesthetic as well as functional components of the wearable electronic device. Also, although not illustrated in FIG. 1, the wearable electronic device 100 may include a wrist strap, which may attach to a mounting structure 115 of the casing 110. The image sensor 120 may capture images of objects in its field of view 125. The image sensor 120 may be disposed in about the same position as a contemporary watch winding/setting knob that protrudes from the bezel. However, the image sensor 120 need not protrude from the wearable electronic device. For example, the image sensor 120 may be generally positioned on the right side of the casing 110, which may face towards a wearer's left hand when the wearable electronic device 100 is worn on the wearer's left wrist, or the image sensor 120 may be generally positioned on the left side of the casing 110, which may face towards a wearer's right hand when the wearable electronic device 100 is worn on the wearer's right wrist. In an embodiment, the wearable electronic device 100 may include a first image sensor 120 generally positioned on the left side of the casing 110 and a second image sensor 120 generally positioned on the right side of the casing 110. In this embodiment including the first and second image sensors 120, either or both of the first and second image sensors 120 may be activated automatically or in response to a manual user selection received, for example, via the display 130. For instance, the wearable electronic device 100 may be configured to automatically determine that it is being worn on the left wrist (e.g. based on the movement or use of the wearable electronic device 100 and/or other suitable factors) and thus automatically activate the second image sensor 120 generally positioned on the right side of the casing 110 at an appropriate time. The display 130 may include more than one visual indication region, such as an input display region 132 for showing entered user inputs and a virtual keyboard display region 134 for showing visual indications of what input characters/functions correspond to the position and/or movement of the wearer's finger 19.

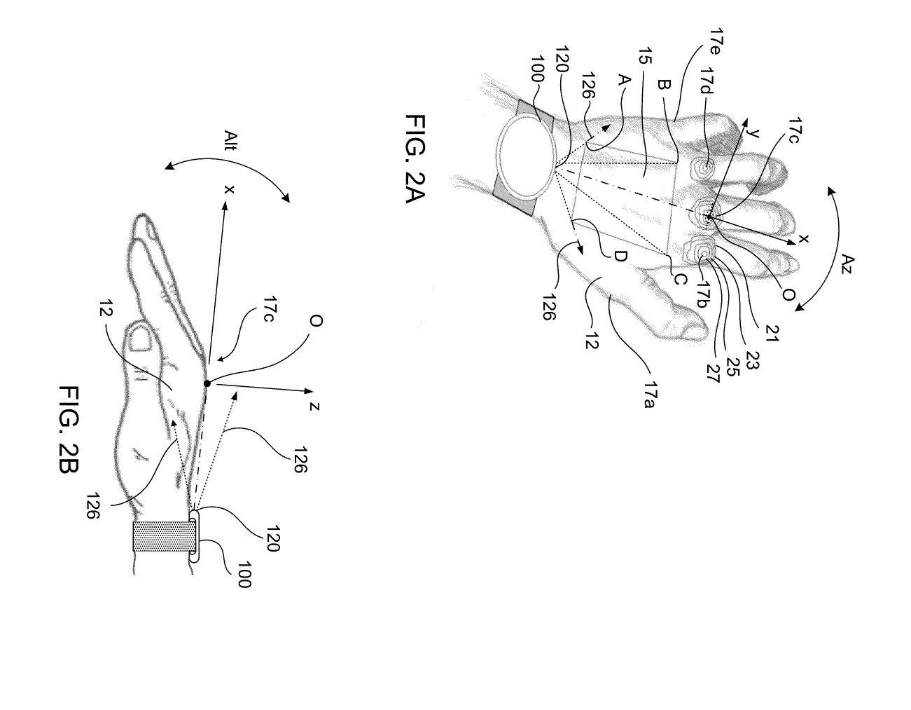

FIG. 2A illustrates a plan view of an embodiment wearable electronic device 100 on a wearer's wrist, emphasizing anatomical features and regions of the back of the wearer's hand. FIG. 2B illustrates a side elevation view of the wearable electronic device 100 on a wearer's wrist shown in FIG. 2A. For illustrative purposes, FIG. 2A shows a hand 12 with five prominent knuckles 17a-e nearest the image sensor 120. The three central knuckles 17b-d are illustrated to include contour lines 21, 23, 25, 27 to emphasize the identifiable rises in surface level. A peak of one of the center knuckles 17b-d, once identified from imaging, may be used as an anatomical feature defining a point of origin O for a frame of reference. An x-axis for the frame of reference may be established from a centerline extending from the image sensor 120 through the point of origin O. Similarly, a y-axis extending laterally and a z-axis extending vertically, each from the point of origin O and the x-axis may together establish an x, y, z coordinate system of the frame of reference.

Images captured by the image sensor 120 may be analyzed in order to detect and/or identify anatomical features, such as one or more the knuckles 17b-d. The analysis may use the intensity of pixels in a captured image, applying suitable spatial filtering to smooth-out noise, in order to detect anatomical features. The analysis may extract features identified from the image, such as a particular curve or profile in the image. In addition, a template image may be used from a calibration step prior to operation. Captured images may then be compared to the template image as part of an analysis. For example, using a least-squares analysis or similar calculation methods a curve describing the shape of an anatomical feature, such as a knuckle, may be matched to a similar curve derived from a template image of that anatomical feature stored in memory. Another calibration technique may use an object, such as a finger from the wearer's other hand, to touch an anatomical feature used as a point of reference. Once detected, the one or more anatomical features of the wearer may be used to determine a frame of reference for an anatomical input surface.

Additionally, a position in space of those anatomical features may change over time relative to the image sensor 120 due to normal movements of a wearer's anatomy. For example, ambulation of a wearer's wrist may change an angle and slightly change a distance of a knuckle on the adjoining hand relative to the image sensor. Thus, it may be advantageous to use a readily identifiable anatomical feature since it may need to be repeatedly identified for updating the position of the frame of reference relative to the image sensor 120. Thus, relative to a first fixed position in space of the frame of reference, lateral wrist movements may create a measurable azimuth angle (Az), while raising or lower the wrist may create a measurable altitude angle (Alt).

As described above, the position of the virtual keyboard and its related frame of reference may be fixed relative to an identified anatomical feature on the wearer. In this way, the virtual keyboard may have a predetermined position relative to one or more anatomical features. Alternatively, the wearer may select the position of the virtual keyboard by touching (i.e., bringing an object in contact with) the anatomical input surface as a form of reference input. The frame of reference may be fixed relative to a reference position of that portion of the anatomical input surface contacted when providing that reference input (i.e., during a calibration phase). For example, when calibrating the wearable electronic device, an initial contact of an object on or near an anatomical region (e.g., the back of the wearer's hand), may establish a reference position for determining the frame of reference of the virtual keyboard.

Using an established frame of reference, the processor of the wearable electronic device may define boundaries within an anatomical input surface 15. FIG. 2A shows four corners A, B, C, D marking boundaries of an anatomical input surface 15. Such corners A, B, C, D may lie virtually anywhere within the edges 126 of the image sensor's field of view. In addition, the anatomical input surface boundaries may be virtually any shape and need not be defined by straight boundaries. Although the closest boundaries are illustrated exactly on the field of view edges 126, they may be spaced away and more clearly within the field of view of the image sensor 120. In this way, the processor of the wearable electronic device may associate various particular positions within the boundaries on the anatomical input surface 15 with a particular input value, like keys on a keyboard. As an object, like a finger, is placed on or over a portion of the anatomical input surface the processor of the wearable electronic device may provide the wearer with a visual indication of the associated input value on a display of the wearable electronic device.

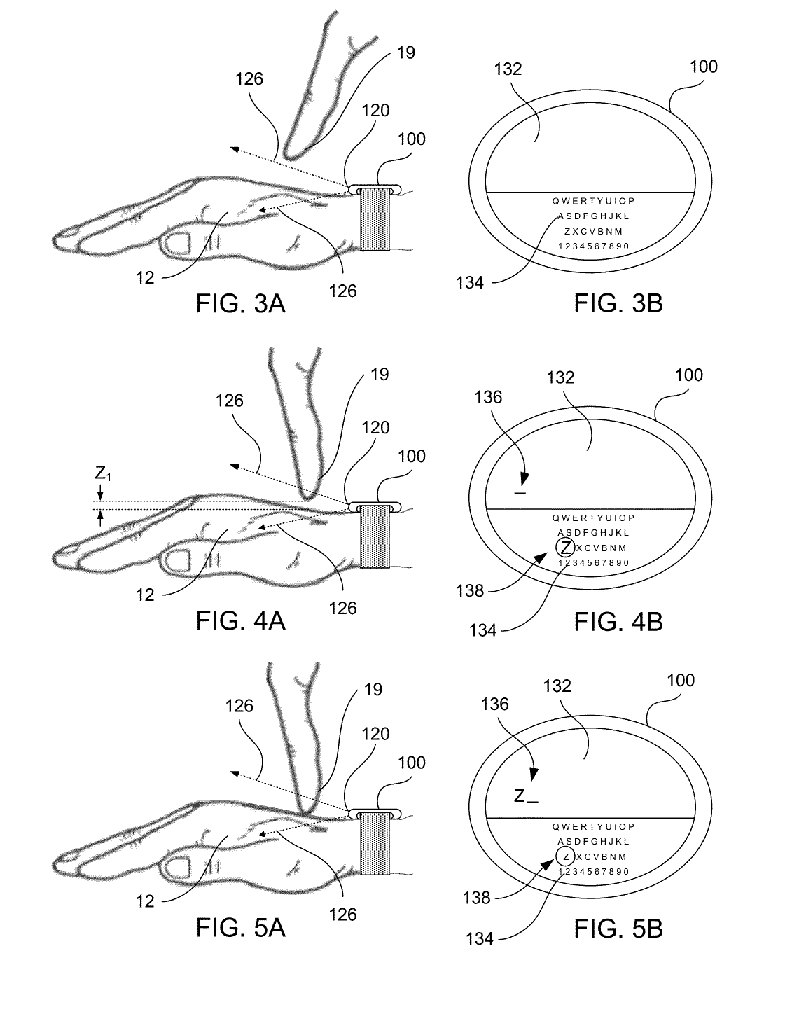

FIGS. 3A, 4A, 5A illustrate side elevation views of a wearable electronic device with a finger in various positions relative to an anatomical input surface in accordance with various embodiments. Also, related FIGS. 3B, 4B, 5B illustrate visual indications on the display of the wearable electronic device, in accordance with various embodiments, that correspond to the finger positions shown in FIGS. 3A, 4A, 5A respectively.

In FIG. 3A illustrates an object, in the form of a wearer's finger 19, approaching the back of the wearer's hand 12. In this position, the finger 19 is outside an edge 126 of the field of view of the image sensor 120. Since the finger 19 is not within the field of view, no particular visual indication needs to be provided as it relates to that input object and the anatomical input surface.

FIG. 3B illustrates an exemplary wearable electronic device 100, having two distinct display regions 132, 134. The upper display region 132 may be configured to act like a conventional input display showing inputs already entered or other display information intended for display. The lower display region 134 may provide visual indications of what input characters/functions correspond to the position of the wearer's finger 19. As the finger position in FIG. 3A is outside the field of view of the image sensor 120, related FIG. 3B shows only a basic display of input characters with no particular character emphasized over any other. Alternatively, when no object is within the image sensors field of view the lower display region 134 may be blank or the upper display region 132 may be extended to a larger portion of the overall display.

FIG. 4A illustrates the tip of the wearer's finger 19 now within the edges 126 of the field of view of the image sensor 120 of the wearable electronic device 100. In this illustrative example, the wearer's finger 19 is now hovering over a portion of the anatomical input surface. An analysis of an image of that finger 19 and its position relative to the anatomical input surface by the processor may determine at least two-dimensional characteristics. First, the processor may determine that the finger 19 is positioned over a particular portion of the anatomical input surface associated a particular input value, such as the character “z”. Second, the processor may determine that the finger 19 is spaced away from the anatomical input surface (i.e., not touching the hand 12) by a distance Z₁. A useful distinction may be made between when an object contacts the anatomical input surface as opposed to when it hovers over that surface. In particular, touching the anatomical input surface may be treated like pressing a key on a keyboard and is thus considered a “user input selection.” A “user input selection” as used herein refers to an input value taken in or operated on by the processor as an intended user input. Thus, the wearer touching a particular portion of the anatomical input surface may be considered an input value the wearer intends to enter, like pressing a key on a keyboard. In contrast, when a user hovers over the anatomical input surface it may be useful to provide a visual indication on the display as to what input character is associated with that portion of the surface. A visual indication of such hovering may be referred to as a “pre-selection input.” A “pre-selection input” as used herein refers to an input value also taken in or operated on by the processor but treated as not yet intended by the wearer to be entered. The position shown in FIG. 4A may be treated by a processor of the wearable device as a pre-selection input position for the finger 19. Providing a visual indication of a pre-selection input may allow a wearer to only focus their attention on the wearable electronic device screen and adjust the position of their finger until they hover over the desired character.

FIG. 4B illustrates the wearable electronic device 100 with visual indications 136, 138 in the display regions 132, 134 reflecting the hovering position shown in FIG. 4A. Both visual indications 136, 138 are not necessary, but such visual indication redundancies may be helpful to more clearly inform a wearer of input changes. The upper visual indication 136 may include a cursor, which may blink, letting the wearer know the device is prepared to receive input. The lower visual indication 138 may include enhancing the appearance of at least one of a plurality of input values in the display. The plurality of input values are the various alphanumeric characters in the virtual keyboard displayed. In this example, making the character “z” larger than the other characters and showing a circle around it enhances its appearance and makes it stand out relative to the other input values. Alternatively, other enhancements may be used such as color changes, blinking characters, highlighting or other emphasis of the pre-selection input character. As a further alternative, changing all the other non-selected characters, such as by dimming, changing color or making the other characters smaller enhances the appearance of the pre-selection input character. Changing the non-preselection input characters may make the non-altered character stand out. Presenting a visual indication on the wearable electronic device of such pre-selection inputs may avoid the need of requiring the input surface or object used for input to have input receiving technology. In other words, the wearer can use her bare finger and a bare hand and does not need a special stylus or pad.

FIG. 5A illustrates the wearer's finger 19 in contact with the anatomical input surface of the wearer's hand 12. In this position, the finger 19 is well within the edges 126 of the field of view of the image sensor 120 of the wearable electronic device 100. An analysis of an image of that finger 19 and that finger's position relative to the anatomical input surface may determine the contact and the corresponding input value. This illustrative finger position may correspond to a particular user input selection, such as the input value “z.”

FIG. 5B illustrates the wearable electronic device 100 with visual indications 136, 138 in the display regions 132, 134 reflecting the user input selection shown in FIG. 5A. The upper visual indication 136 reflects the input value “z” has been entered and the cursor has shifted. Alternatively, the cursor need not reappear until a pre-selection input is identified. The lower visual indication 138 may reflect a complete de-enhancement or partial change in the appearance of the selected input character. In this example, the character “z” is partially de-enhanced by making it the same size as the other characters but leaving the circle around. Such a partial de-enhancement may provide a visual indication to the wearer that reflects the finger is still in contact with that corresponding portion of the anatomical input surface. Alternatively, other de-enhancements may be used, such as color changes, blinking stops, highlighting is removed or other emphasis of the input selection character.

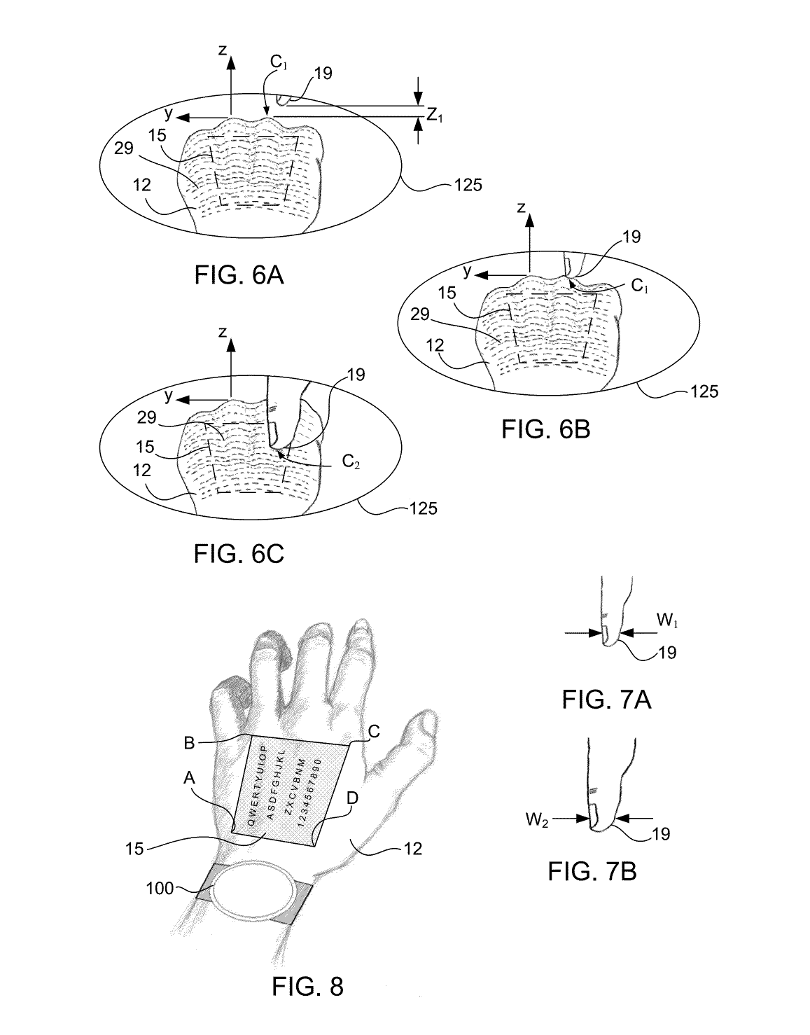

FIGS. 6A-C illustrate two-dimensional field of view images from the perspective of the image sensor of the wearable electronic device. From the perspective of being mounted on the wearer's wrist facing the hand, the field of view 125 may include the back of the wearer's hand 12. Also, once an object such as the wearer's finger 19 comes into view, the object too may be visible in the field of view 125. The dotted contour lines 29 are added for illustrative purposes to emphasize topographical variations on the back of the wearer's hand 12. Such topographical variations may not be as easily discernible from a two dimensional image as features like the wearer's knuckles. Thus, in order to improve the determination during image analysis of when an object contacts the anatomical input surface a calibration procedure may be performed. For example, the wearer may be asked during calibration to contact one or more positions on the back of the hand or particularly on the anatomical input surface 15.

FIG. 6A shows the wearer's fingertip 19 just barely coming into view and clearly separated from a closest contact point C₁ by a vertical (i.e., along the z-axis) distance Z₁. Due to the orientation of the image sensor 120 relative to the anatomical input surface 15, a distinction may be made between when an object is touching a surface versus when the object is hovering over the position (i.e., not in contact with the surface). Additional information may be derived from images in order to make determinations regarding how far away an object is from the image sensor (i.e., depth in the image). In particular, since objects that are closer appear larger, the size or just the width of an object may be used to determine its position along the x-axis (toward the background of the image).

FIG. 6B shows the wearer's fingertip 19 touching the third knuckle at the contact point C₁, which may be a reference point for the frame of reference. In contrast, FIG. 6C shows the wearer's fingertip 19 now touching a position within the anatomical input surface 15 at the contact point C₂. A noticeable distinction that may be derived from the images shown in FIGS. 6B and 6C is the width of the fingertip 19. FIGS. 7A and 7B further emphasize this distinction. The finger 19 visible in FIG. 6B, which corresponds to the fingertip also shown in FIG. 7A, has a smaller width W₁. This smaller width W₁ may be correlated to a finger position furthest away from the image sensor, but still able to contact the contact point C₁. The finger 19 visible in FIG. 6C, which corresponds to the fingertip also shown in FIG. 7B, has a larger width W₂. That larger width W₂ may be used to determine a position of the finger along the x-axis. Also, a simple estimator, such as the mean position of the finger along the y-axis, may be used along with the x-axis coordinates to determine the position of the contact point C₂ on the anatomical input surface 15. In this way, the object size may be used to determine its depth position within the image. As mentioned above, a calibration procedure may be performed when setting up the wearable electronic device, which may place a most commonly used input object (i.e., the wearer's finger) on one or more reference points, in order to know a reference width that corresponds to a particular depth along the x-axis.

FIG. 8 illustrates an embodiment wearable electronic device 100 and an adjacent anatomical input surface on a wearer's hand 12. Various alphanumeric characters arranged on the anatomical input surface 15 as well as a grey area representing the anatomical input surface itself are illustrated for the purpose of explanation. The various alphanumeric characters shown represent user inputs associated with those respective positions within the corners A, B, C, D marking the boundaries of an anatomical input surface 15. In this way, placing an object in one of those positions may be associated with a user input of the corresponding character. For example, using a pointing device and touching the anatomical input surface 15 where the letter “G” is located may be considered a user input selection of the letter “G.” The arrangement of input value positions may be in rows similar to a keyboard, forming a virtual keyboard. Such rows may be parallel to one another, divergent from one another fanning-out toward separate knuckles or almost any configuration. Ergonomic considerations may be taken into account in order to provide optimum ease and comfort when using the anatomical input surface. Additionally, it may be helpful to align at least one row with an anatomical reference point in order to provide a secondary visual indication to the wearer of the natural frame of reference associated with those rows. For example, the top row may be aligned with the second knuckle from the outside, while the remaining rows remain parallel to that top row. Alternatively, the top and bottom rows may be aligned with knuckles, while the center rows may be almost aligned with the troughs between knuckles.

A physical template and/or projected image of the alphanumeric characters, the anatomical input surface or just the boundary of the anatomical input surface need not be provided on the wearer's hand because a visual indication of an input value may be provided on the display of the wearable electronic device 100. However, alternatively a physical template may be used and/or the wearable electronic device 100 may include a projector that projects characters and/or symbols onto the anatomical input surface to guide the wearer. As a further alternative, a physical template or a projected image of the anatomical input surface alone or just the outline thereof may be provided to assist or train the wearer.

As described above, the position of the virtual keyboard and its related frame of reference may be fixed relative to a reference input provided to calibrate the wearable electronic device. Contacting a portion of the anatomical input surface may provide the reference input. The point of contact may establish a reference position and the frame of reference fixed relative thereto. In accordance with various embodiments, a processor may also provide a visual indication during a calibration phase of the wearable electronic device. For example, the processor may provide a visual indication associated with the reference input. The initial contact location of a wearer's finger or other object (i.e., the reference input) may be represented on the wearable device display as a special character, such as the asterisk symbol (“*”), separate from the main virtual keyboard. As a further alternative, the initial contact location of the wearer's finger or other object may correspond to a predetermined input value, such as the “Q” on the virtual keyboard. Also, as described above with regard to FIGS. 4B and 5B, a visual indication may be provided on the display as to which virtual keyboard position has been selected. For example, the appearance on the display of the special character or the predetermined input value may be enhanced, such as by highlighting, enlarging, or otherwise changing. Thus, a relative position of the virtual keyboard may be determined from where the wearer's finger first touches the back of his hand.

The position of the virtual keyboard relative to the initial contact position of the object (i.e., the finger) may be determined as a function of the position of the object relative to the field of view of the image sensor. For example, if an initial contact location of the object is too close to an edge of the field of view or on an input surface that is obscured or not clearly visible, the virtual keyboard may be placed closer to the opposite edge of the image sensor field of view in order to encourage the wearer to move towards an area more clearly visible to the image sensor. Also, the position of the virtual keyboard relative to the initial contact position may depend on which edge of the field of view the initial contact occurs. For example, if the initial contact position is near a left edge of the field of view, the virtual keyboard may be disposed to the right thereof or if the initial contact position is near a right edge of the field of view, the virtual keyboard may be disposed to the left thereof.

In addition to the input values recognized from touching or hovering over the anatomical input surface, other easily recognized locations may be used to receive input. For example, the same anatomical feature uses to establish the frame of reference may act as a “Home” button for navigating between screens of a smartphone version of the wearable electronic device.

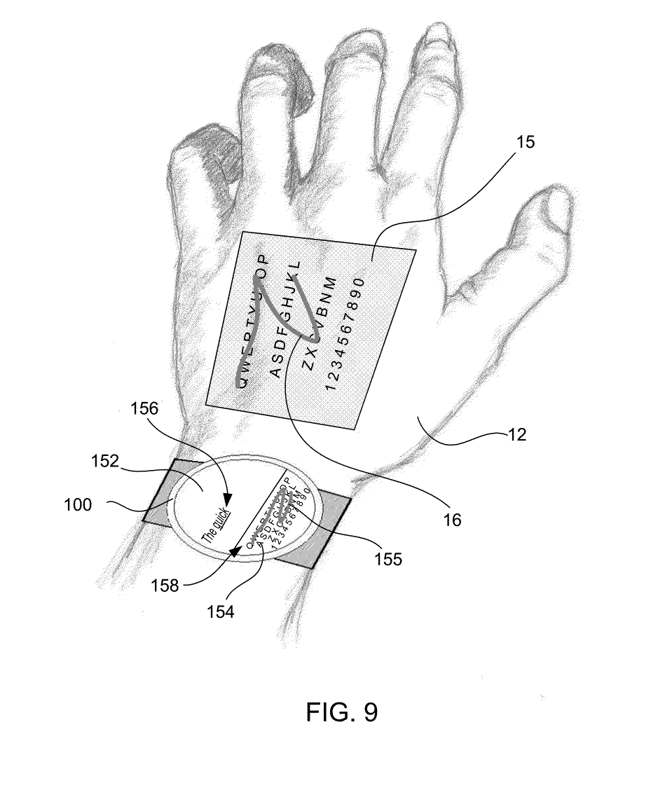

FIG. 9 illustrates a wearable electronic device 100, an adjacent anatomical input surface 15 on the wearer's hand 12, and a visual indication of a wearer swipe input in accordance with various embodiments. A grey area representing the anatomical input surface 15, as well as various alphanumeric characters therein, are illustrated for the purpose of explanation. A physical template or visual projection of these elements need not actually be provided on the wearer, but may be if desired. Also, a swipe input forming a path 16 traced by the wearer on the anatomical input surface 15 is illustrated to explain a further method and system of receiving input in an embodiment wearable electronic device. The path 16 may not necessarily be visible on the back of the user's hand, but may be visible as a virtual path 155 on a display of the wearable electronic device 100. For example, the wearable electronic device 100 may include an input display region 152 and a keyboard display region 158 includes an actual display of alphanumeric characters 154. The keyboard display region 158 may show the virtual path 155 as the wearer traces an object across the anatomical input surface 15. The virtual path 155 may be a solid or translucent line. Alternatively, highlighting all the characters over which the path traces may represent the virtual path 155. When tracing a path 16 on the anatomical input surface 15 the wearer may adjust the position of their finger to pass over the desired character(s). The virtual path 155 on the keyboard display region provides a visual indication to the user as to swipe input being traced. In this way, the wearer may enter words by sliding a finger or stylus from the first letter of a word to its last letter, lifting only between words. A processor of the wearable electronic device may use error-correction algorithms, predictive text and/or language modeling to guess the intended word 156. For example, based on the actual path 16, which touches the letters, “Q,” “U,” “I,” “C” and “K” the intended word 156 may be predicted to be the word “quick,” as illustrated. Input of a predefined gesture, such as a finger flick on the input surface 15, in response to display of the predicted text may allow a user to accept or reject the prediction. Additional text completion features may be included to speed-up and/or simplify user input to the device.

In various embodiments the break between each swipe input word may be denoted by various means. For example, the lifting of the input object, such as a finger or stylus, from the anatomical input surface 15 may represent the end of a word. Similarly, the contact with the anatomical input surface 15 may represent the beginning of a word. Alternatively, the start and/or end of a word may be marked by a particular gesture, such as a small circle on top of the desired start/finish position of the anatomical input surface 15 corresponding to that input value. Additionally, characters in the keyboard display region 158 may appear highlighted or otherwise enhanced to provide a visual indication that the wearer has paused in a position corresponding to that value.

In an embodiment, the wearable electronic device may include one or more gesture sensors for detecting finger, hand and/or wrist movements associated with particular gestures. One or more gesture sensors may be included on the underside of the wearable electronic device itself or a strap of the wrist worn device. The types and placement of the sensor(s) may be matched to the underlying biomechanics of the hand. For example, miniature pressure or force sensors may be used to detect contraction of one tendon in the forearm or wrist of the wearer. Such sensors included in the strap of a wearable electronic device operatively coupled to a processor thereof may provide input corresponding to movements of the wearer. In particular, movements of the fingers, wrist and/or hand may be distinguished in order to recognize a gesture corresponding to such movements. In response to recognizing a gesture associated with a particular command or function, other features/functions of the wearable electronic device may be activated, such as the image sensor and visual indications provided from object positioning, as described above.

As used herein, the term “gesture sensor” refers to a sensor capable of detecting movements associated with gestures, particularly finger, hand and/or wrist movements associated with predetermined gestures for activating features/functions of the wearable electronic device. A gesture sensor may be able to transmit to a processor input corresponding to a movement by a wearer of the wearable electronic device. In various embodiments, the gesture sensor may be particularly suited and/or situated to detect finger, hand and/or wrist movements.

A gesture sensor may include more than one sensor and/or more than one type of sensor. Exemplary gesture sensor in accordance with an embodiment include pressure sensors configured to detect skin surface changes, particularly at or near the wrist, gyroscopes, electromyography (EMG) sensor, and accelerometers, the data from which may be processed to recognize movement gestures. EMG is a technique for evaluating and recording the electrical activity produced by the movement of skeletal muscles. An EMG sensor may detect signals in the form of the electrical potential generated by muscle cells when these cells are electrically or neurologically activated. The gesture sensor signals may be analyzed to detect biomechanics of various muscular movements of a wearer, such as movements of the finger, hand, and/or wrist. An EMG gesture sensor may measure movement activity by detecting and amplifying the tiny electrical impulses that are generated in the wrist. Yet another form of gesture sensor may include one or more conductive textile electrodes placed in contact with the skin, which may detect changes caused by muscle motion, tissue displacement, and/or electrode deformation.

The wearable electronic device processor may be programmed to recognize particular gestures for activating functions/features. It may be advantageous to program the processor to recognize simple gestures. However, overly common movements may cause the wearer to inadvertently or unintentionally activate features of the wearable electronic device. Also, in addition to recognizing gestures used to activate features, other simple gestures may perform other function or be recognized as input of particular characters, symbols or words. Additionally, gestures may be combined for functions such as scrolling from left to right or scrolling from top to bottom in the display. Similarly, the processor may be programmed to recognize a combination of gestures to activate particular features, such as having the display of a smartwatch change to show a home screen.

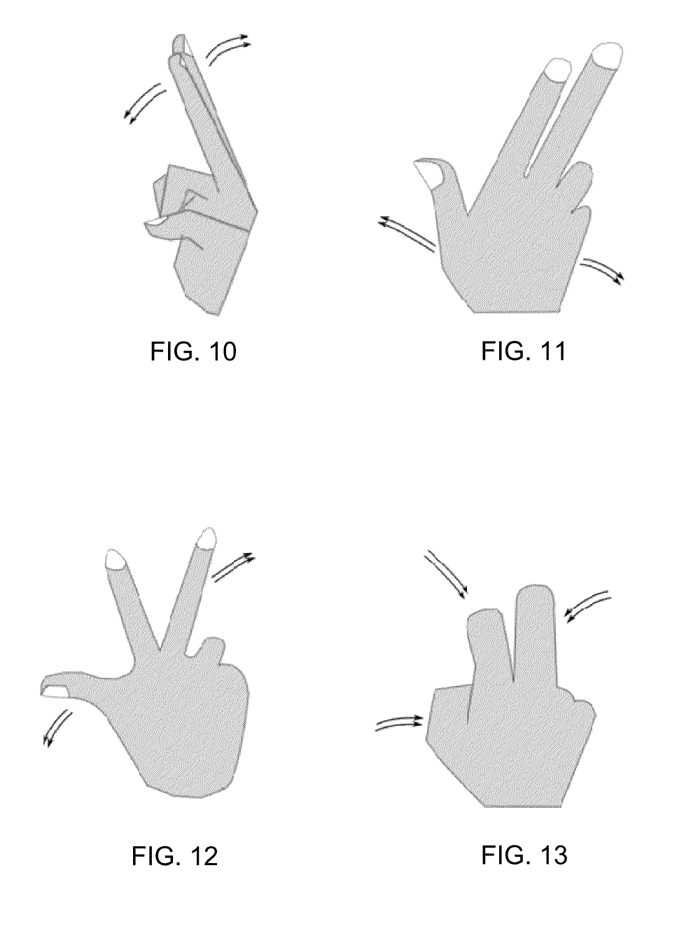

FIGS. 10-13 illustrate various exemplary gestures that may be recognized for providing input to a wearable electronic device. FIG. 10 illustrates the index and middle fingers of a hand moving together in an “up and down” motion. FIG. 11 illustrates a combination of the thumb, index, and middle fingers of a hand moving together in a “side-to-side” motion. FIG. 12 illustrates the thumb, index, and middle fingers of a hand moving in an “outward” motion (i.e., spreading apart). FIG. 13 illustrates the thumb, index, and middle fingers of a hand moving in an “inward” motion, where the knuckles of those fingers also bend. In various embodiment, one or more gestures may be used be used to activate a function/feature of the wearable electronic device. The use of more than one gesture may ensure the wearer intends the input detected by the gesture sensors.

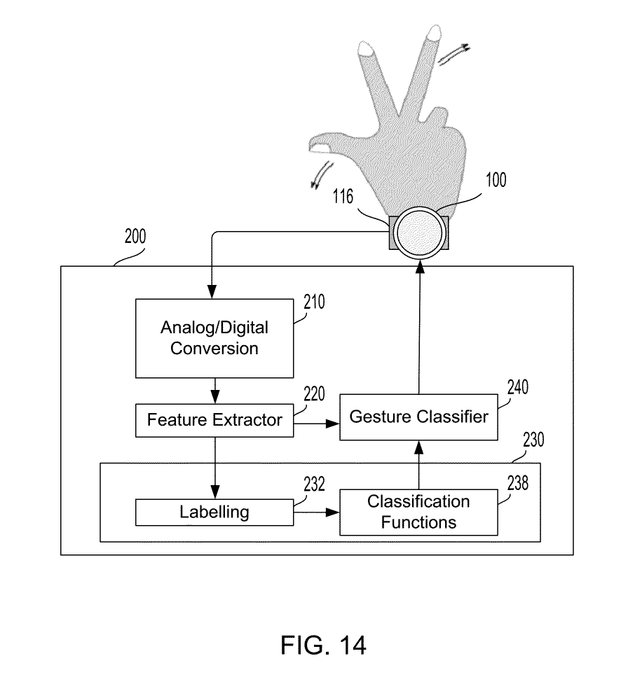

FIG. 14 illustrates functional modules for gesture recognition in an embodiment wearable electronic device 100 including a gesture analysis module 200. One or more gesture sensors may be disposed in a wristband 116 or on an underside of the wearable electronic device 100 in contact with the wearer's skin. An output from one or more gesture sensors may be an analog output. An analog/digital conversion module 210 may digitize such an analog output. The digitized signal may be broken down and analyzed by a feature extractor module 220 in order to identify patterns or features of measured movements. Such patterns or features may be input to a gesture classifier module 240. In this way, certain gesture classifications may activate functions of the wearable electronic device 100, while other patterns or features need not be acted upon if considered noise. Additionally, a training module 230 may receive the identified patterns or features from the feature extraction module 220. The training module 230 may include a labeling module 232 and a classification functions module 238 for informing the gesture classifier module 240 about the distinct gestures that need to be acted upon. The training module 230 may use a machine-learning algorithm, such as a K-means clustering or a supervised learning model, such as support vector machines (SVM). For example, using support vector machines the feature space may be the peak or average amplitude of the signals received from each sensor. An output of the training module 230 may be a set of decision functions that may be used to classify either real or test data into distinct gestures. A processor of the wearable electronic device 100 may receive only appropriate classified gestures that may activate functions.

A processor may provide more robust gesture recognition by including input from more than one gesture sensor in either real or test data. Also, the input from gesture sensors may be categorized and processed by a gesture analysis module and/or inference engine to recognize gestures corresponding to particular movements by a wearer. Supervised machine learning algorithms may be employed for distinguishing the different movements from the potentially noisy signal data.

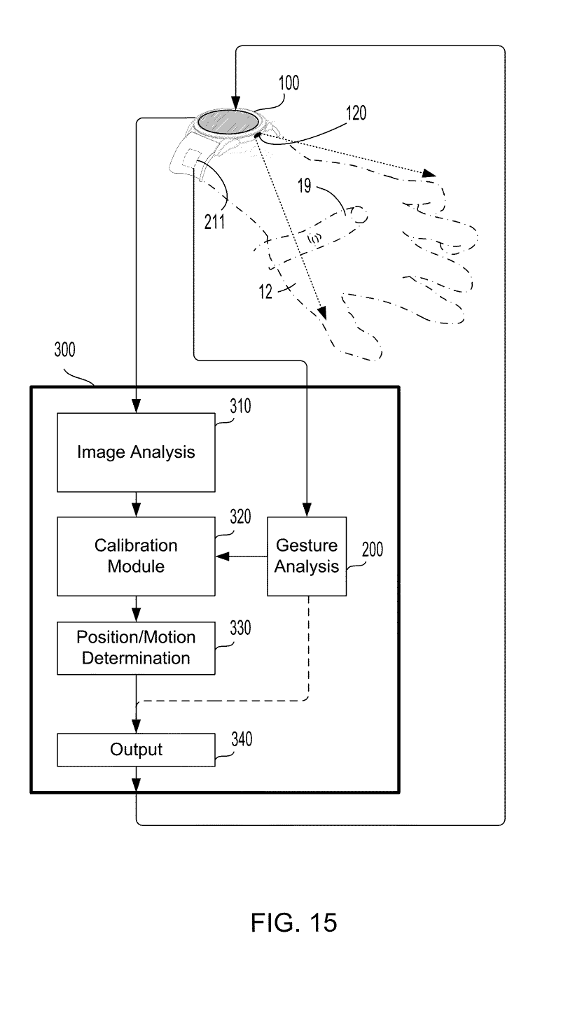

FIG. 15 illustrates functional modules for enhanced input recognition in a wearable electronic device 100 using an inference engine 300. The wearable electronic device may capture images, such as a finger 19 adjacent the wearer's hand 12. An inference engine 300 may analyze an output from the onboard image sensor 120. As part of the inference engine 300, an image analysis module 310 may receive and analyze the raw image data and detect anatomical features. Also, the image analysis module 310 may detect objects, such as a finger 19, in the captured image. Based on the image analysis a frame of reference may be determined and/or verified by a calibration module 320. With a frame of reference determined and/or verified, a position/motion determination module 330 may locate an object or track its movement. The object's location or movement may be translated, based on corresponding input values, to a visual indication or functional command by an output module 340, which may be acted upon by a processor of the wearable electronic device 100.

Additionally, one or more gesture sensors 211 may be used in conjunction with the image sensor 120 to calibrate and/or confirm position determinations made from captured images. In this way, the gesture analysis module 200 receiving input from the gesture sensor(s) 211 may contribute its own output to the calibration module 320. For example, pressure sensors may detect a particular tilt of the hand relative to the wrist. Thus an algorithm, such as a Bayesian inference algorithm, may provide soft estimates of the altitude and/or azimuth angles created. Those soft estimates may then be compared in the calibration module 320 to determinations made from the image analysis. Alternatively, in response to the image sensor being turned off or in a stand-by mode, the gesture analysis module 200 may provide the output module 340 with an indication that a command should be output to turn on the image sensor.

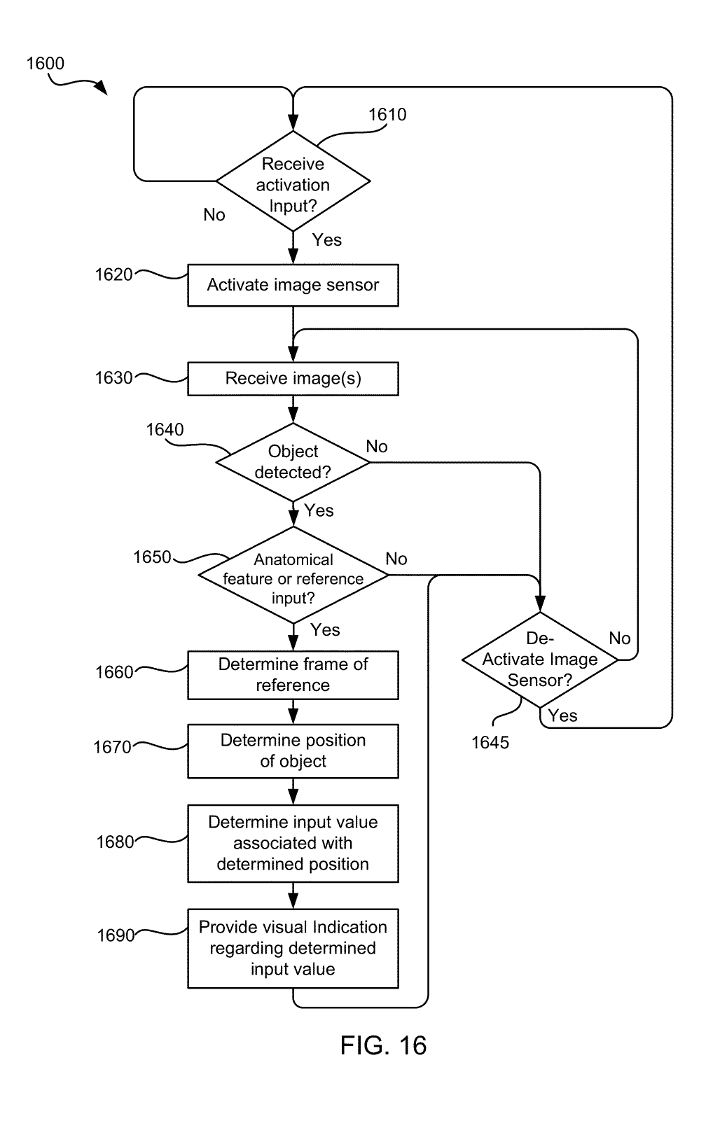

FIG. 16 illustrates an embodiment method 1600 of receiving input in a wearable electronic device that may be performed by a processor of a wearable electronic device. In determination block 1610, the processor may determine whether an activation input is received to activate the image sensor. The activation input may be received automatically when the wearable electronic device is turned on. Alternatively, the image sensor may remain off or dormant while the wearable electronic device is on and only activated by an activation input received from a control operated by the wearer or some other trigger.

Considering the image sensor may expend a significant amount of power, it may be desirable to provide one or more different ways of avoiding unintentionally enabling the image sensor and/or virtual keyboard functions. For example, redundant activation inputs or at least two different activation inputs may be required before enabling the image sensor. Alternatively, the wearer may engage a physical button on the wearable electronic device in order enable the image sensor.

In response to determining that an activation input is received (i.e., determination block 1610=“Yes”), the image sensor may be activated in block 1620. In conjunction with the activation of the image sensor, it may be useful to provide a visual, audio and/or haptic (e.g., vibration) indication to the wearer that the image sensor has been activated. In response to determining that no an activation input is received (i.e., determination block 1610=“No”), the processor may await such an activation input before initiating the rest of the method 1600 or repeat the determination in determination block 1610.

With the image sensor active, an image may be received in block 1630. The received image may be a first image of a series of images analyzed in series or in parallel by a processor of the wearable electronic device. Alternatively, the received image may include more than one image analyzed collectively in accordance with the subsequent blocks described below.

In determination block 1640, the processor may determine whether an object is detected in the received image. In response to determining that no object is detected in the received image (i.e., determination block 1640=“No”), the processor may determine whether to deactivate the image sensor in determination block 1645. In response to detecting an object in the received image (i.e., determination block 1640=“Yes”), the processor may calibrate itself by locating an anatomical feature and determining a frame of reference. Thus, in response to determining that an object is detected in the received image (i.e., determination block 1640=“Yes”), the processor may determine whether an anatomical feature or reference input is detected in the received image or whether a reference input was previously established in determination block 1650. In response to determining that no anatomical feature or reference input is detected in the received image and that no reference input was previously established (i.e., determination block 1650=“No”), the processor may determine whether it is appropriate to deactivate the image sensor in determination block 1645.

The determination in determination block 1645 regarding whether to deactivate the image sensor may be based on an input received from the wearer, a particular software event, a timed trigger for conserving power in response to certain conditions (i.e., no activity, objects or anatomical features detected for a predetermined period of time) or other settings of the wearable electronic device. In response to determining that the image sensor should be deactivated (i.e., determination block 1645=“Yes”), the processor may again determine whether an activation input is received in determination block 1610. In response to determining that the image sensor should not be deactivated (i.e., determination block 1645=“No”), the processor may receive further images from the image sensor in block 1630.

In response to detecting an anatomical feature or a reference input in the received image or that a reference input was previously established (i.e., determination block 1650=“Yes”), the processor may determine a frame of reference in block 1660. Also, the processor may determine a position of the object detected in the received image with respect to the determined frame of reference in block 1670. In block 1680 an input value associated with the determined position may be determined. Thus, a visual indication regarding the determined input value may be provided on a display of the wearable electronic device in block 1690 by applying the determinations from blocks 1660, 1670, 1680.

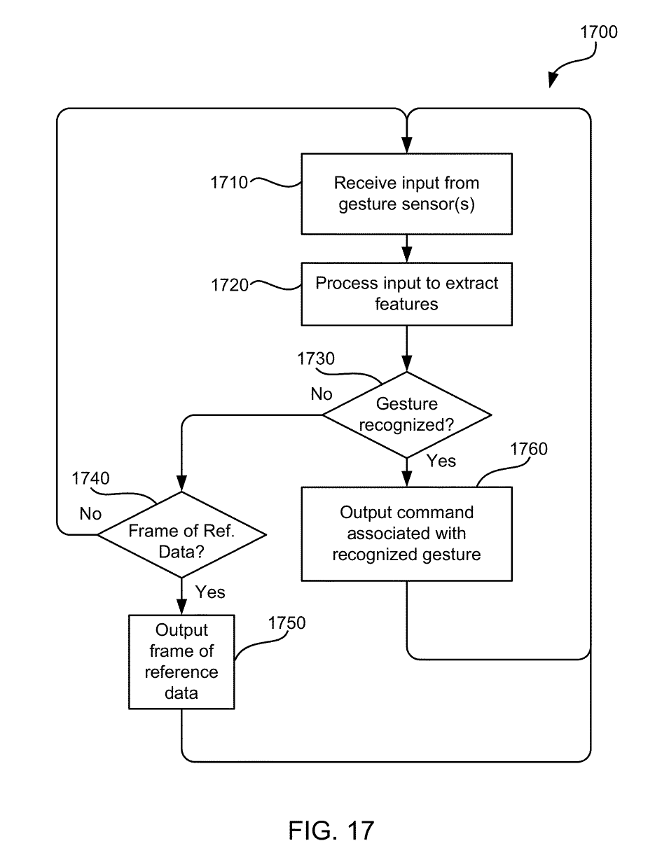

FIG. 17 illustrates an embodiment method 1700 of receiving input in a wearable electronic device that may be performed by a processor of the wearable electronic device. In block 1710, an input may be received from one or more gesture sensors. The received input from the gesture sensor(s) may be referred to as “gesture input.” The gesture input may thus be processed in block 1720 to extract features. In determination block 1730, the processor may determine whether at least one gesture is recognized based on the extracted features.

In response to determining that no gesture is recognized from the extracted features (i.e., determination block 1730=“No”), the processor may determine whether any frame of reference data may be derived from the extracted features in determination block 1740. In response to determining that no frame of reference data may be derived from the extracted features (i.e., determination block 1740=“No”), the processor may await receipt of further input from the gesture sensor in block 1710. In response to determining that frame of reference data may be derived from the extracted features (i.e., determination block 1740=“Yes”), the processor may output such frame of reference data in block 1750. The output of such frame of reference data may include storing that data in a memory for use in future feature extractions (i.e., block 1720) and/or gesture recognition determinations (i.e., determination block 1730). When frame of reference data is output in block 1750, the processor may await receipt of further input from the gesture sensor in block 1710.

In response to determining that an extracted feature matches a recognized gesture (i.e., determination block 1730=“Yes”), a command associated with the recognized gesture may be output in block 1760. For example, the recognized gesture may activate certain features of the wearable electronic device or trigger a particular visual indication in a display of the wearable electronic device. In particular, the recognized gesture may indicate the image sensor should be activated. In which case, the input received in block 1710 may be considered an activation input as described above with regard to determination block 1610 in FIG. 16. Additionally, in response to the recognized gesture indicating the image sensor should be activated, the command output in block 1760 may be an image sensor activation command. When a command associated with the recognized gesture is output in block 1750, the processor may await receipt of further input from the gesture sensor in block 1710.

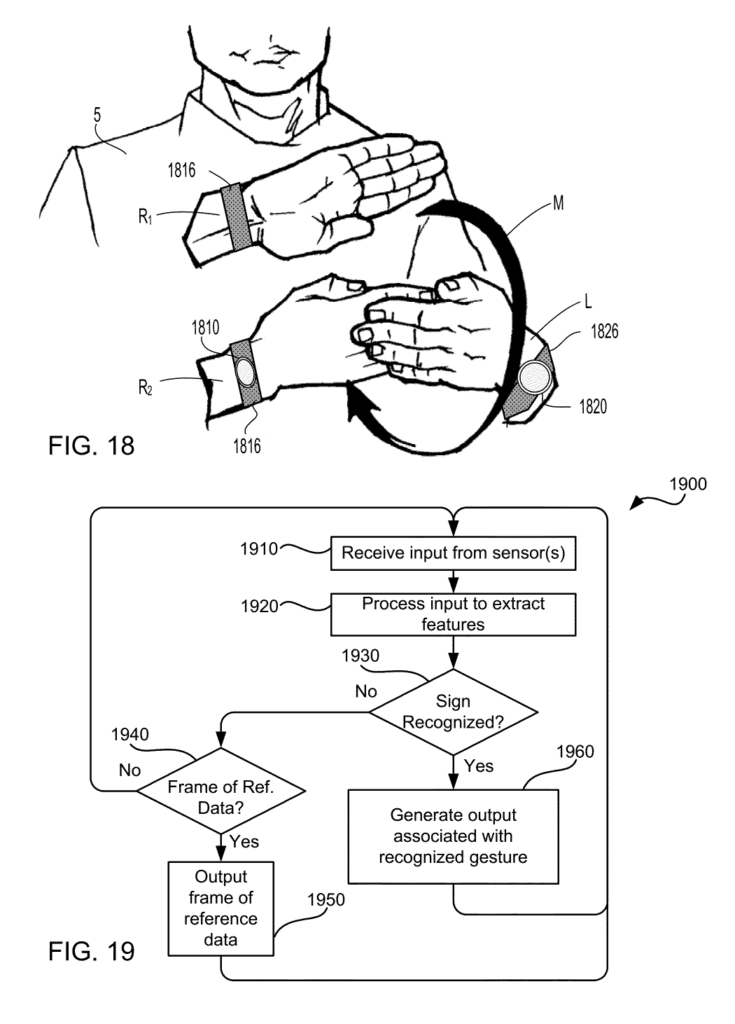

FIG. 18 illustrates two wearable electronic devices used together to detect a movement gesture by a wearer in accordance with various embodiments. The wearer 5 is shown wearing a first wearable electronic device 1810 on a right wrist R₁, R₂ and a second wearable electronic device 1820 on a left wrist L. A subscript distinguishes the right wrist in a first position (R₁) with the palm facing away from the wearer 5 and a second position (R₂) with the palm facing toward the wearer 5 after making a circular movement M around the left wrist L. In American Sign Language, this movement may be associated with the terms “all,” “whole,” or “entire.” Each of the first and second wearable electronic devices 1810, 1820 includes an image sensor and at least one gesture sensor, similar to those described above regarding other embodiments. The wearable electronic devices 1810, 1820 need not be the same. For example, one wearable electronic device 1820 may include a full-featured display, while the other wearable electronic device 1810 need not include a display or may include a smaller display. The first wearable electronic device 1810 includes a wrist-strap 1816 that may include one or more of the gesture sensors embedded therein (sensors not shown). In addition, the second wearable electronic device 1820 includes a wrist-strap 1826 that may include one or more of the gesture sensors embedded therein (sensors not shown). Additional sensors may be provided for two wearable electronic devices used together in order to coordinate the motions of the pair of devices (e.g., including ultrasound ranging technologies) may be provided to coordinate the motions.

One wearable electronic device 1810 may include a transmitter and the other wearable electronic device 1820 may include a receiver for one device to communicate with the other. Alternatively, each wearable electronic device 1810, 1820 may include a transceiver (both a transmitter and a receiver) in order to allow bidirectional communications. In this way, one wearable electronic device 1810 may communicate inputs from onboard sensors to the other wearable electronic device 1820 for recognizing gestures using two hands. Also, in addition to detecting certain sign language movements, combined gestures using two hands may be used to activate features on one or both of the wearable electronic devices 1810, 1820.

FIG. 19 illustrates an embodiment method 1900 of receiving input in a wearable electronic device that may be performed by a processor in at least one of two wearable electronic devices may perform the operations of method 1900. In particular, one wearable electronic device may be worn on each of the wearer's wrists for interpreting complex gestures using two hands, such as those gestures associated with sign language. In block 1910, input may be received by the processor from combined sensors in both wearable electronic devices. Each of the two wearable electronic devices may include any of the sensors described above, including the image sensor and the gesture sensors. In contrast to the image sensor analyses in embodiments described above, the interpretation of signs does not need to detect an object near an anatomical input surface. Rather a configuration of one or more anatomical features detected from image analysis may be used alone or in conjunction with other sensor input in order to detect a particular hand configuration. For example, input from an image sensor along with an accelerometer and a gyroscope may be combined to detect a particular movement of a hand along with the configuration in which that hand is held during the movement. The received inputs from the combined sensors in each of the two wearable electronic devices may be analyzed separately by a processor in each device or combined by a processor in only one device.

In block 1920, one or more processors may analyze the sign language input to extract features. In determination block 1930, the processor may determine whether at least one “sign” is recognized based on the extracted features. A “sign” as used in this context refers to a gesture or action used to convey words, commands or information, such as gestures used in a system of sign language. In response to determining that no sign is recognized from the extracted features (i.e., determination block 1930=“No”), the processor(s) may determine whether any frame of reference data may be derived from the extracted features in determination block 1940. In response to determining that no frame of reference data may be derived from the extracted features (i.e., determination block 1940=“No”), the processor may await receipt of further input from the combined sensors in block 1910. In response to determining that frame of reference data may be derived from the extracted features (i.e., determination block 1940=“Yes”), the processor(s) may output such frame of reference data in block 1950. The output of such frame of reference data may include storing that data in a memory for use in future feature extractions (i.e., block 1920) and/or gesture recognition determinations (i.e., determination block 1930). When frame of reference data is output in block 1950, the processor may await receipt of further input from the gesture sensor in block 1910. Additionally, frame of reference data may include a partially recognized sign, such as a gesture from only one of the two wearable electronic devices. In this way, the frame of reference data output in block 1950 may be considered when further input is received from the other of the two wearable electronic devices. Thus, an input received from the other of the two wearable electronic devices immediately following the partially recognized gesture may be combined and recognized as a complete gesture in determination block 1930.

In response to determining that an extracted feature matches a recognized gesture (i.e., determination block 1930=“Yes”), the processor may implement a command associated with the recognized gesture in block 1960. For example, the recognized gesture may activate certain features of the wearable electronic device or trigger a particular visual indication in a display of the wearable electronic device. When a command associated with the recognized gesture is output in block 1950, the processor(s) may await receipt of further input from the sensor(s) in block 1910.

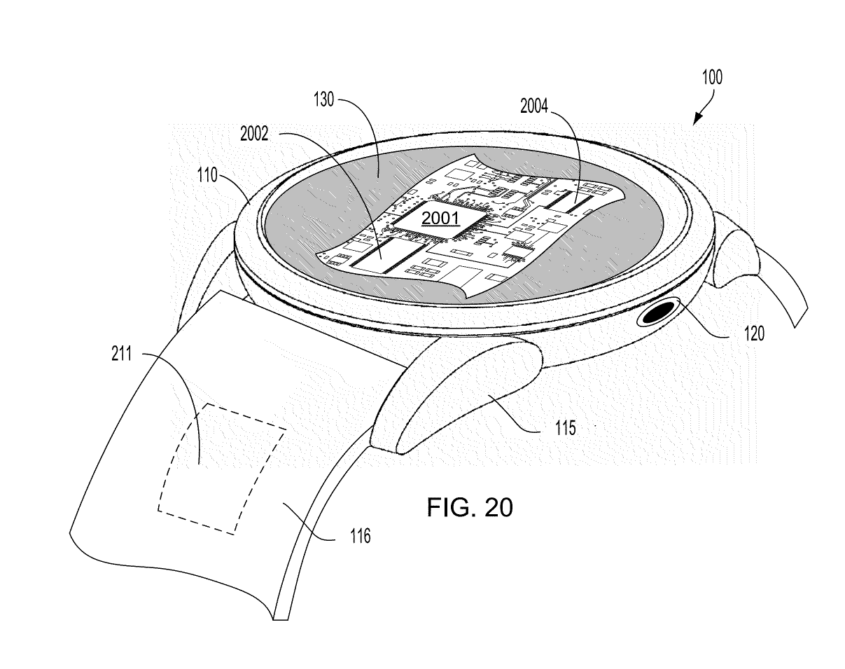

FIG. 20 illustrates an embodiment wearable electronic device 100 including a housing 110, an image sensor 120, a display 130, a strap mounting structure 115, a wrist strap 116, and a gesture sensor 211. The gesture sensor 211 may include more than one such sensor arranged in various locations along the length of the wrist strap 116 to ensure contact with skin covering one or more bony structures and/or tendons of the wearer. The wearable electronic device 100 may further include physical input mechanisms (in the form of an activation button and/or toggle switch—not illustrated), which may be located on the bezel.

The wearable electronic device may include one or more processor(s) 2001 configured with processor-executable instructions to receive inputs from the sensors, as well as generate outputs for the display or other output elements. The sensors, such as an image sensor 120 and gesture sensor 211 may be used as means for receiving signals and/or indications. The processor(s) may be used as means for performing functions or determining conditions/triggers, such as whether patterns match or as means for detecting an anatomical feature, a reference input or determining a frame of reference. In addition, a display or speaker may be used as means for outputting. The processor may be coupled to one or more internal memories 2002, 2004. Internal memories 2002, 2004 may be volatile or non-volatile memories, which may be secure and/or encrypted memories, or unsecure and/or unencrypted memories, or any combination thereof. The processor 2001 may be any programmable microprocessor, microcomputer or multiple processor chip or chips that can be configured by software instructions (i.e., applications) to perform a variety of functions, including the functions of various aspects described above. Multiple processors may be provided, such as one processor dedicated to one or more functions and another one or more processors dedicated to running other applications/functions. Typically, software applications may be stored in the internal memory 2002, 2004 before they are accessed and loaded into the processor. The processor 2001 may include internal memory sufficient 2002, 2004 to store the application software instructions. In many devices the internal memory 2002, 2004 may be a volatile or nonvolatile memory, such as flash memory, or a mixture of both. For the purposes of this description, a general reference to memory refers to memory accessible by the processor including internal memory or removable memory plugged into the hearing aid and memory within the processor.

The processors in various embodiments described herein may be any programmable microprocessor, microcomputer or multiple processor chip or chips that can be configured by software instructions (applications/programs) to perform a variety of functions, including the functions of various embodiments described above. Typically, software applications may be stored in the internal memory before they are accessed and loaded into the processors. The processors may include internal memory sufficient to store the processor-executable software instructions. In many devices, the internal memory may be a volatile or nonvolatile memory, such as flash memory, or a mixture of both. For the purposes of this description, a general reference to memory refers to memory accessible by the processors including internal memory or removable memory plugged into the device and memory within the processor themselves.

In one or more exemplary embodiments, the functions described may be implemented in hardware, software, firmware, or any combination thereof. If implemented in software, the functions may be stored as one or more instructions or code on a non-transitory computer readable storage medium or non-transitory processor-readable storage medium. The steps of a method or algorithm may be embodied in a processor-executable software module, which may reside on a non-transitory computer readable or processor-readable storage medium. Non-transitory computer readable or processor-readable storage media may be any storage media that may be accessed by a computer or a processor. By way of example but not limitation, such non-transitory computer readable or processor-readable media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above are also included within the scope of non-transitory computer readable and processor-readable media. Additionally, the operations of a method or algorithm may reside as one or any combination or set of codes and/or instructions on a non-transitory processor-readable medium and/or computer readable medium, which may be incorporated into a computer program product.

The foregoing method descriptions and the process flow diagrams are provided merely as illustrative examples and are not intended to require or imply that the blocks of various embodiments must be performed in the order presented. As will be appreciated by one of skill in the art the order of blocks in the foregoing embodiments may be performed in any order.

Words such as “thereafter,” “then,” “next,” etc. are not intended to limit the order of the blocks; these words are simply used to guide the reader through the description of the methods. Further, any reference to claim elements in the singular, for example, using the articles “a,” “an” or “the” is not to be construed as limiting the element to the singular. Additionally, as used herein and particularly in the claims, “comprising” has an open-ended meaning, such that one or more additional unspecified elements, steps and aspects may be further included and/or present.

The various illustrative logical blocks, modules, circuits, and process flow diagram blocks described in connection with the embodiments may be implemented as electronic hardware, computer software, or combinations of both. To clearly illustrate this interchangeability of hardware and software, various illustrative components, blocks, modules, circuits, and blocks have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The preceding description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the following claims and the principles and novel features disclosed herein.

What is claimed is:

1. A method of receiving input in a wearable electronic device worn by a wearer from positioning an object near the wearable electronic device, the method comprising:
receiving an image from an image sensor;
determining from the image an input position of the object near the wearable electronic device with respect to a frame of reference relative to an anatomical input surface on the wearer of the wearable electronic device;
determining whether the determined input position is one of a plurality of positions associated with an input value; and
providing a visual indication regarding the input value on a display of the wearable electronic device in response to determining that the determined input position is one of the plurality of positions associated with the input value.

2. The method of claim 1, further comprising:
detecting from the image an anatomical feature on the wearer of the wearable electronic device; and
determining the frame of reference fixed relative to the anatomical feature, wherein the frame of reference defines the plurality of positions associated with the input value as being at least one of on the anatomical input surface and hovering over the anatomical input surface on the wearer of the wearable electronic device.

3. The method of claim 1, further comprising:
receiving a reference input from the image sensor corresponding to the object being in contact with a portion of the anatomical input surface, wherein the frame of reference is fixed relative to a reference position of the contacted portion of the anatomical input surface.

4. The method of claim 1, further comprising:
receiving an input from a gesture sensor of the wearable electronic device corresponding to a movement by the wearer;
processing the input with an inference engine to recognize a gesture corresponding to the movement by the wearer; and
activating the image sensor for receiving the image in response to recognizing the gesture.

5. The method of claim 1, wherein the anatomical input surface is disposed on a same anatomical appendage of the wearer as the wearable electronic device.

6. The method of claim 1, wherein the image sensor is included in the wearable electronic device.

7. The method of claim 1, wherein the input value is associated with an input selection in response to the determined input position corresponding to the object being in contact with a portion of the anatomical input surface.

8. The method of claim 1, wherein the input value is associated with a pre-selection input in response to the determined input position corresponding to the object hovering over a portion of the anatomical input surface.

9. The method of claim 1, wherein the visual indication includes enhancing an appearance of at least one of a plurality of input values displayed on the wearable electronic device.

10. A wearable electronic device, comprising:
an image sensor;
a display;
a memory; and
a processor coupled to the image sensor, the display and the memory, wherein the processor is configured with processor-executable instructions to perform operations comprising:
receiving an image from the image sensor;
determining from the image an input position of an object near the wearable electronic device with respect to a frame of reference relative to an anatomical input surface on a wearer of the wearable electronic device;
determining whether the determined input position is one of a plurality of positions associated with an input value; and
providing a visual indication regarding the input value on the display of the wearable electronic device in response to determining that the determined input position is one of the plurality of positions associated with the input value.

11. The wearable electronic device of claim 10, wherein the processor is configured with processor-executable instructions to perform operations further comprising:
detecting from the image an anatomical feature on the wearer of the wearable electronic device;
determining the frame of reference fixed relative to the anatomical feature, wherein the frame of reference defines the plurality of positions associated with the input value as being at least one of on the anatomical input surface and hovering over the anatomical input surface on the wearer of the wearable electronic device.

12. The wearable electronic device of claim 10, wherein the processor is configured with processor-executable instructions to perform operations further comprising:
receiving a reference input from the image sensor corresponding to the object being in contact with a portion of the anatomical input surface, wherein the frame of reference is fixed relative a reference position of the contacted portion of to the anatomical input surface.

13. The wearable electronic device of claim 10, further comprising a gesture sensor coupled to the processor, wherein the processor is configured with processor-executable instructions to perform operations further comprising:
receiving an input from the gesture sensor of the wearable electronic device corresponding to a movement by the wearer;
processing the input with an inference engine to recognize a gesture corresponding to the movement by the wearer; and
activating the image sensor for receiving the image in response to recognizing the gesture.

14. The wearable electronic device of claim 10, wherein the processor is configured with processor-executable instructions to perform operations such that the anatomical input surface is disposed on a same anatomical appendage of the wearer as the wearable electronic device.

15. The wearable electronic device of claim 10, wherein the input value is associated with at least one of an input selection and a pre-selection input, wherein the input value is an input selection in response to the determined input position corresponding to the object being in contact with a portion of the anatomical input surface, and wherein the input value is the pre-selection input in response to the determined input position corresponding to the object hovering over the portion of the anatomical input surface.

16. The wearable electronic device of claim 10, wherein the processor is configured with processor-executable instructions to perform operations such that the visual indication includes enhancing an appearance of at least one of a plurality of input values on the display.

17. A wearable electronic device configured to be worn by a wearer for receiving input from positioning an object near the wearable electronic device, comprising:
means for receiving an image from an image sensor;
means for determining from the image an input position of the object near the wearable electronic device with respect to a frame of reference relative to an anatomical input surface on the wearer of the wearable electronic device;
means for determining whether the determined input position is one of a plurality of positions associated with an input value; and
means for providing a visual indication regarding the input value on a display of the wearable electronic device in response to determining that the determined input position is one of the plurality of positions associated with the input value.

18. The wearable electronic device of claim 17, further comprising:
means for detecting from the image an anatomical feature on the wearer of the wearable electronic device;
means for determining the frame of reference fixed relative to the anatomical feature, wherein the frame of reference defines the plurality of positions associated with the input value as being at least one of on the anatomical input surface and hovering over the anatomical input surface on the wearer of the wearable electronic device.

19. The wearable electronic device of claim 17, further comprising
means for receiving a reference input from the image sensor corresponding to the object being in contact with a portion of the anatomical input surface, wherein the frame of reference is fixed relative to a reference position of the contacted portion of the anatomical input surface.

20. The wearable electronic device of claim 17, further comprising:
means for receiving an input from a gesture sensor of the wearable electronic device corresponding to a movement by the wearer;
means for processing the input with an inference engine to recognize a gesture corresponding to the movement by the wearer; and
means for activating the image sensor for receiving the image in response to recognizing the gesture.

21. The wearable electronic device of claim 17, wherein the anatomical input surface is disposed on a same anatomical appendage of the wearer as the wearable electronic device.

22. The wearable electronic device of claim 17, wherein the input value is associated with at least one of an input selection and a pre-selection input, wherein the input value is an input selection in response to the determined input position corresponding to the object being in contact with a portion of the anatomical input surface, and wherein the input value is the pre-selection input in response to the determined input position corresponding to the object hovering over the portion of the anatomical input surface.

23. The wearable electronic device of claim 17, wherein the visual indication includes means for enhancing an appearance of at least one of a plurality of input values displayed on the wearable electronic device.

24. A non-transitory processor-readable storage medium having stored thereon processor-executable instructions configured to cause a processor in a wearable electronic device to perform operations comprising:
receiving an image from an image sensor;
determining from the image an input position of an object near the wearable electronic device with respect to a frame of reference relative to an anatomical input surface on a wearer of the wearable electronic device;
determining whether the determined input position is one of a plurality of positions associated with an input value; and
providing a visual indication regarding the input value on a display of the wearable electronic device in response to determining that the determined input position is one of the plurality of positions associated with the input value.

25. The non-transitory processor-readable storage medium of claim 24, wherein the stored processor-executable instructions are configured to cause the processor to perform operations further comprising:
detecting from the image an anatomical feature on the wearer of the wearable electronic device;
determining the frame of reference fixed relative to the anatomical feature, wherein the frame of reference defines the plurality of positions associated with the input value as being at least one of on the anatomical input surface and hovering over the anatomical input surface on the wearer of the wearable electronic device.

26. The non-transitory processor-readable storage medium of claim 24, wherein the stored processor-executable instructions are configured to cause the processor to perform operations further comprising:
receiving a reference input from the image sensor corresponding to the object being in contact with a portion of the anatomical input surface, wherein the frame of reference is fixed relative to a reference position of the contacted portion of the anatomical input surface.

27. The non-transitory processor-readable storage medium of claim 24, wherein the stored processor-executable instructions are configured to cause the processor to perform operations further comprising:
receiving an input from a gesture sensor of the wearable electronic device corresponding to a movement by the wearer;
processing the input with an inference engine to recognize a gesture corresponding to the movement by the wearer; and
activating the image sensor for receiving the image in response to recognizing the gesture.

28. The non-transitory processor-readable storage medium of claim 24, wherein the stored processor-executable instructions are configured to cause the processor to perform operations such that the anatomical input surface is disposed on a same anatomical appendage of the wearer as the wearable electronic device.

29. The non-transitory processor-readable storage medium of claim 24, wherein the stored processor-executable instructions are configured to cause the processor to perform operations such that:
the input value is associated with at least one of an input selection and a pre-selection input;
the input value is an input selection in response to the determined input position corresponding to the object being in contact with a portion of the anatomical input surface; and
the input value is the pre-selection input in response to the determined input position corresponding to the object hovering over the portion of the anatomical input surface.

30. The non-transitory processor-readable storage medium of claim 24, wherein the stored processor-executable instructions are configured to cause the processor to perform operations such that the visual indication includes enhancing an appearance of at least one of a plurality of input values displayed on the wearable electronic device.
